(19) United States
(12) Patent Application Publication
(10) Pub. No.: US 2024/0267311 A1
(43) Pub. Date: Aug. 8, 2024

(54) DETERMINING LATENCY AT A PHYSICAL LAYER

(71) Applicant: Microchip Technology Incorporated, Chandler, AZ (US)

(72) Inventors: Dixon Chen, Shenzhen (CN); Jiachi Yu, Foshan (CN); Kevin Yang, Shenzhen (CN); Venkatraman Iyer, Austin, TX (US); Nihat Kaya, Rheinstetten (DE)

(21) Appl. No.: 18/430,152

(22) Filed: Feb. 1, 2024

(30) Foreign Application Priority Data
Feb. 2, 2023 (CN) 202310121644.5

(51) Int. Cl. H04L 43/0852; H04L 69/323

(52) U.S. Cl. CPC H04L 43/0852; H04L 69/323

(57) ABSTRACT

One or more examples relate, generally, to a method that includes: recording a value representing a time duration for a frame moving toward a cable or MAC to travel between a predetermined reference plane of a PHY-MAC interface to a predetermined reference plane of a PHY-able interface; and asserting an indication that the recorded value is available to be read from a PHY.

### PRIORITY CLAIM

This application claims the benefit of the filing date of Chinese Patent Application Serial No. CN202310121644.5, filed Feb. 2, 2023, the disclosure of which is incorporated herein in its entirety by this reference.

### TECHNICAL FIELD

One or more examples relate, generally, to determining latency at a physical layer, including a physical layer that has variable or unknown latency. One or more examples relate, generally, to determining latency at a 10SPE physical layer. One or more examples relate, generally, to reporting the determined latency of a physical layer to a higher layer device, such as a media access controller, and, optionally, to synchronizing a clock of a media access controller utilizing such reported latency.

### BACKGROUND

Interconnects are widely used to facilitate communication among devices of a network, sub-systems and systems. Generally speaking, electrical signals are transmitted on a physical medium (e.g., a bus, a coaxial cable, or a twisted pair, without limitation—generically referred to simply as a “line” or a “bus”) by the devices coupled to the physical medium.

According to the Open Systems Interconnection model (OSI model), Ethernet-based computer networking technologies use baseband transmission (i.e., electrical signals are discrete electrical pulses) to transmit data packets and ultimately frames that are communicated among network devices. According to the OSI model, specialized circuitry called a physical layer (PHY) device or controller is used to interface between an analog domain of a line and a digital domain of a data link layer (also referred to herein simply as a “link layer”) that operates according to packet signaling. While the data link layer may include one or more sublayers, in Ethernet-based computer networking, a data link layer typically includes at least a media access control (MAC) layer that provides control abstraction of the physical layer. By way of non-limiting example, when transmitting data to another device on a network, a MAC controller may prepare frames for the physical medium, add error correction elements, and implement collision avoidance. Further, when receiving data from another device, a MAC controller may ensure integrity of received data and prepare frames for higher layers.

There are various network topologies that implement physical layers and link layers (and may include other layers, without limitation). The Peripheral Component Interconnect (PCI) standard and the Parallel Advanced Technology Attachment (Parallel ATA) standard, both in use since the early 1990's, may implement a multidrop bus topology. The trend since the early 2000's has been to use point-to-point bus topologies, for example, the PCI Express standard (PCIe) and the Serial ATA (SATA) standard implement point-to-point topologies.

A typical point-to-point bus topology may implement lines between each device (e.g., dedicated point-to-point, without limitation) or lines between devices and switches (e.g., switched point-to-point, without limitation). In contrast, in a multidrop bus topology, a physical transmission medium is a shared bus and each network device is coupled to the shared bus, for example, via a circuit chosen based on the type of physical medium (e.g., coaxial or twisted pair, without limitation).

Point-to-point bus topologies, such as a dedicated point-to-point topology or a switched point-to-point topology, require more wires and more expensive material than multidrop topologies due, in part, to the greater number of links between devices. In certain applications, such as automotive, there may be physical constraints that make it difficult to directly connect devices, and so a topology that does not require, or does not require as many, direct connections (e.g., a multidrop topology, without limitation) in a network or a sub-network may be less susceptible to, or hampered by, such constraints.

Devices that are on a baseband network of a multidrop network, without limitation, share the same physical transmission medium, and typically use the entire bandwidth of that medium for transmission (stated another way, a digital signal used in baseband transmission occupies the entire bandwidth of the media). As a result, only one device on a baseband network may transmit at a given instant. So, media access control methods are sometimes used to handle contention for such a shared transmission medium.

### BRIEF DESCRIPTION OF THE DRAWINGS

To easily identify the discussion of any particular element or act, the most significant digit or digits in a reference number refer to the figure number in which that element is first introduced.

FIG. 1 is a diagram depicting an apparatus to determine latency at a 10SPE PHY, in accordance with one or more examples.

FIG. 2 is a diagram depicting an apparatus to determine latency at a 10SPE PHY, in accordance with one or more examples.

FIG. 3A is a diagram depicting an apparatus to detect a presence of a frame at a predetermined reference plane of a PHY-MAC interface and at a predetermined reference plane of a PHY-Cable interface, in accordance with one or more examples.

FIG. 3B illustrates an aspect of the subject matter in accordance with one embodiment.

FIG. 4 is a timing diagram depicting a transfer a frame, in accordance with one or more examples.

FIG. 5 is a flow diagram depicting a process to determine latency at a 10SPE PHY, in accordance with one or more examples.

FIG. 6 is a flow diagram depicting a process to determine latency at a 10SPE PHY, in accordance with one or more examples.

FIG. 7 is a flow diagram depicting a process to determine latency of a 10SPE PHY, in accordance with one or more examples.

FIG. 8A is a flow diagram depicting a process to determine a presence of a frame at a predetermined reference plane of a 10SPE PHY, in accordance with one or more examples.

FIG. 8B is a is a flow diagram depicting a process to determine a presence of a frame at a predetermined reference plane of a 10SPE PHY, in accordance with one or more examples.

FIG. 9 is a flow diagram depicting a clock synchronization process, in accordance with one or more examples.

FIG. 10 is a flow diagram depicting a process for cancelling latency of a PHY from time stamp, in accordance with one or more examples.

FIG. 11 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, circuitry, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, circuitry, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, any relational term, such as “over,” “under,” “on,” “underlying,” “upper,” “lower,” etc., is used for clarity and convenience in understanding the disclosure and accompanying drawings and does not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The terms “on” and “connected” may be used in this description interchangeably with the term “coupled,” and have the same meaning unless expressly indicated otherwise or the context would indicate otherwise to a person having ordinary skill in the art.

As used herein, the terms “assert,” “de-assert” and derivatives thereof used in reference to a connection (e.g., a wire, a terminal, a pad, a contact, a circuit, a pin, a combination thereof, or any subcombination thereof, physical or logical, without limitation), means, respectively, to assert or de-assert a signal associated with the connection (e.g., a signal specifically assigned to the connection or a signal to which the connection is specifically assigned, without limitation).

A vehicle, such as an automobile, a truck, a bus, a ship, and/or an aircraft, may include a vehicle communication network. The complexity of the vehicle communication network may vary depending on a number of electronic devices within the network. For example, an advanced vehicle communication network may include various control modules for, as non-limiting examples, engine control, transmission control, safety control (e.g., antilock braking, without limitation), and emissions control. To support these control modules, the automotive industry relies on various communication protocols.

10SPE (i.e., 10 Mbps Single Pair Ethernet, also referred to as “10BASE-TIS”) is a network technology specified by the Institute of Electrical and Electronics Engineers (IEEE) in IEEE 802.3cg™. 10SPE may be used to provide a collision free, deterministic transmission on, e.g., a multi-drop network or shared transmission medium, without limitation.

The 1588 Precision-Time-Protocol (PTP) is a network technology used to synchronize clocks in a computer network specified in IEEE 1588.

In 10SPE, 1588 PTP, in theory, utilizes the media-dependent-interface (MDI) as a reference for generating timestamps. The reference plane is a timing plane associated with the MDI and a 1588 PTP timestamp is intended to represent the time when a predetermined part of a frame crosses the MDI. In 10SPE, 1588 PTP is typically implemented at a MAC, which observes the time when a start-of-frame-delimiter (SFD) inserted in a frame by a transmitting MAC (which could be the same or different MAC depending on whether the frame with the SFD is a receive frame or transmit frame) crosses a media-independent-interface (MII) and then adds or subtracts a value that represents a known fixed-latency (e.g., from the MII to a reference plane close to the MDI, or from a reference plane close to the MDI to the MII, as the case may be) to, or from, the timestamp to determine a time when the SFD crossed the MDI.

Some PHYs exhibit latency that is unknown or variable. As a non-limiting example, latency may be variable (e.g., is potentially different frame to frame, without limitation) in PHYs that include variable delays and variable depth buffers to implement physical layer collision avoidance (PLCA).

The inventors of this disclosure appreciate it may be desirable for a PHY to determine latency or information relevant to determining latency (collectively “latency information”), including without limitation on a frame-by-frame basis. It may be desirable for such a PHY to report or otherwise make latency information available to a MAC. As a non-limiting example, a MAC may utilize such information to determine a time when a data frame crosses a PHY-cable interface, but utilizing such information for other purposes does not exceed the scope of this disclosure.

As used herein, the term “frame” means “Ethernet frame,” including without limitation as defined in IEEE 802.3.

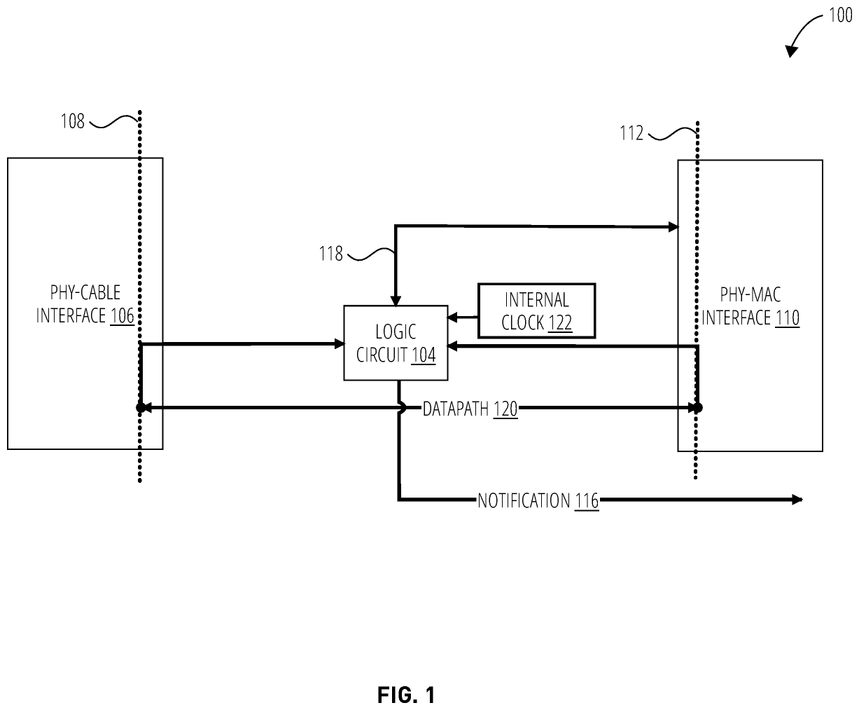

FIG. 1 is a diagram depicting an apparatus 100 to determine (and optionally report) latency at a 10SPE PHY, in accordance with one or more examples. In one or more examples, apparatus 100 may be a PHY or a portion of a PHY, such as a 10SPE PHY, without limitation, and may also be referred to as a “PHY 100.” In one or more examples, apparatus 100 may determine (and, optionally, report) latency of: a frame traveling from a PHY-MAC interface towards a PHY-cable interface, a frame traveling from a PHY-cable interface towards a PHY-MAC interface, or both thereof.

In one or more examples, apparatus 100 includes a PHY-side of a PHY-cable interface 106 (also referred to herein as “PHY-cable interface 106”), a PHY-side of a PHY-MAC interface (also referred to herein as “PHY-MAC interface 110”), a datapath 120, a logic circuit 104, and an internal clock 122.

In one or more examples, predetermined reference plane 108 is of the PHY-cable interface 106 and a predetermined reference plane 112 is of the PHY-MAC interface 110. Non-limiting examples of predetermined reference plane 108 of the PHY-cable interface 106 include predetermined reference plane 108 defined at a location along datapath 120 or at PHY-cable interface 106. Non-limiting examples of predetermined reference plane 112 of the PHY-MAC interface 110 include predetermined reference plane 112 defined at a location along datapath 120 or at PHY-MAC interface 110.

In one or more examples, predetermined reference planes 108, 112 may be respectively set to any location along datapath 120 of a PHY provided that predetermined patterns known to correspond to specific symbols or bits may be reliably detected and the location where the specific symbols or bits are observed are a known fixed latency from the predetermined reference plane such as a known fixed latency from a connection between a PHY and a Cable (e.g., connections of the PHY, without limitation) or a known fixed latency from a connection between a PHY and a MAC. Accordingly, in or more examples, a location where the specific symbols or bits are observed may be the same or different location than where a predetermined reference plane is defined. In various examples, a location where the specific symbols or bits are observed may be referred to herein as an “observed reference plane,” and a location corresponding to an observed reference plane plus or minus a known fixed latency may be understood to be a “predetermined reference plane.”

In one or more examples, exhibited patterns may be compared to predetermined patterns to detect the symbols or bits. Detecting that a frame exhibits a predetermined pattern is utilized as an indication that the frame is present at an associated predetermined reference plane, such as predetermined reference plane 108 or predetermined reference plane 112, or a respective observed reference plane.

Logic circuit 104 detects frames traveling on datapath 120 and calculates a time duration value 118 that represents a time duration for a frame to travel between predetermined reference plane 108 defined at PHY-cable interface 106 and predetermined reference plane 112 defined at PHY-MAC interface 110.

In one or more examples, logic circuit 104 may utilize internal clock 122 of apparatus 100 to determine a time duration (e.g., to count clock cycles, without limitation) for frames traveling on datapath 120 to travel between predetermined reference plane 108 and predetermined reference plane 112.

In one or more examples, internal clock 122 may be different (e.g., different clock signal or clock source, without limitation) than a clock of PHY-MAC interface 110, and the resolution of internal clock 122 may be finer than the resolution of the clock of PHY-MAC interface 110 (e.g., of a clock of an MII or RMII clock, without limitation). In such a case, clock cycle counts or timestamps generated based on internal clock 122 may be closer to actual time that a frame crosses predetermined reference plane 112 than clock cycle counts or timestamps based on an internal clock of PHY-MAC interface 110.

Time duration value 118 calculated by logic circuit 104 may be stored at apparatus 100 or provided to a downstream user via PHY-MAC interface 110. When stored, time duration value 118 is accessible to be read via PHY-MAC interface 110 by a downstream user, as a non-limiting example, a MAC. Apparatus 100, and more specifically, logic circuit 104, may provide a notification 116 that time duration value 118 is ready to be read. Notification 116 may be provided via a signal path that includes PHY-MAC interface 110 or does not include PHY-MAC interface 110 (e.g., via an interrupt connection that does not include PHY-MAC interface 110, without limitation), as illustrated in the non-limiting specific example depicted by FIG. 1.

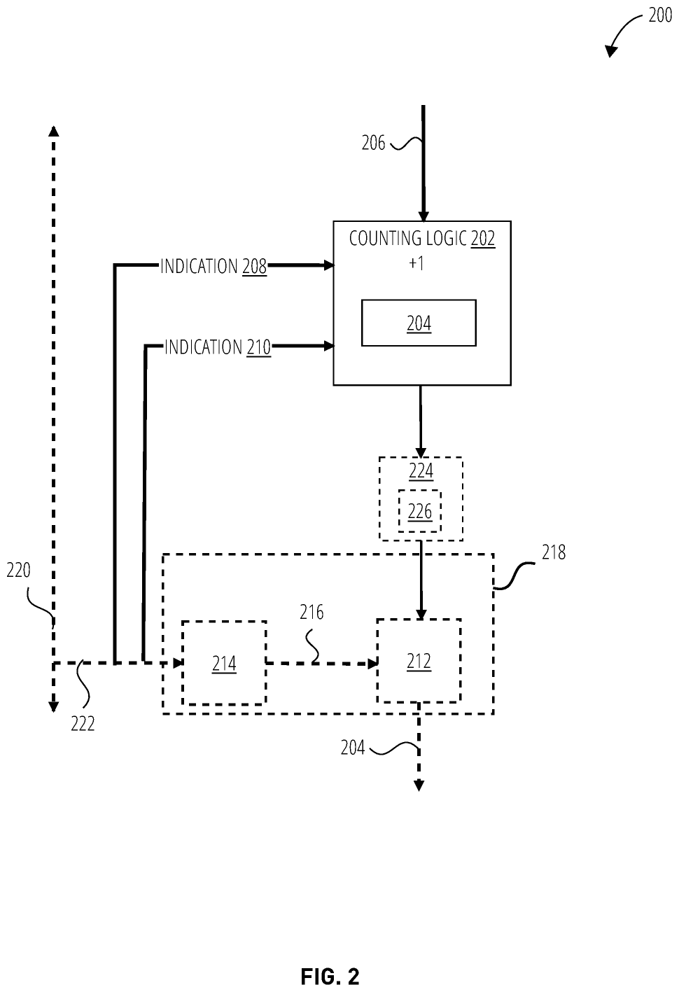

FIG. 2 is a diagram depicting an apparatus 200 for determining latency of a 10SPE PHY, in accordance with one or more examples. Apparatus 200 is a non-limiting example of logic circuit 104 depicted by FIG. 1.

In one or more examples, apparatus 200 includes counting logic 202 to count and store a number of clock cycles (i.e., as counted number of clock cycles 204) at least partially responsive to a clock signal 206 and respective assertions of indication 208 and indication 210. Indication 208 may be an indication of presence of a frame at the predetermined reference plane of a PHY-MAC interface (e.g., at predetermined reference plane 112 defined at PHY-MAC interface 110, without limitation). Indication 210 may be an indication of a presence of the frame at a predetermined reference plane of a PHY-cable interface (e.g., predetermined reference plane 108 defined at PHY-Cable interface 106, without limitation).

In a case of determining latency for a frame traveling from PHY-MAC interface 110 to PHY-cable interface 106, counting logic 202 may start counting clock cycles (e.g., start incrementing counted number of clock cycles 204, without limitation) of clock signal 206 at least partially responsive to an asserted indication 208, and stop counting clock cycles (e.g., stop incrementing counted number of clock cycles 204, without limitation) of clock signal 206 at least partially responsive to an asserted indication 210.

In a case of determining latency for a frame traveling from PHY-cable interface 106 to PHY-MAC interface 110, counting logic 202 may start counting clock cycles (e.g., start incrementing counted number of clock cycles 204, without limitation) of clock signal 206 at least partially responsive to an asserted indication 210, and stop counting clock cycles (e.g., stop incrementing counted number of clock cycles 204, without limitation) of clock signal 206 at least partially responsive to an asserted indication 208.

In one or more examples, counting logic 202 may output a value for counted number of clock cycles 204 representative of a latency. Values output by counting logic 202 may be utilized to directly set time duration value 118 (i.e., time duration value 118 is set equal to the values output by counting logic 202), or may be utilized to indirectly set time duration value 118 (i.e., time duration value 118 is set at least partially based on the values output by counting logic 202, e.g., in combination with other values or adjustments, without limitation).

In the indirect example, counted number of clock cycles 204 output by counting logic 202 may be combined with a predetermined value 226 by optional adjustment logic 224. Predetermined value 226 may represent a difference (e.g., in clock cycles or number of bits, without limitation) between a portion of a frame exhibiting a predetermined pattern (“detectable portion of a frame”) and a portion of interest of a frame. In some cases, the portion of interest of a frame may not be reasonably detectable by apparatus 200. As a non-limiting example, an SFD portion of a preamble of a frame is typically not detectable by apparatus 200 because the bits of the SFD portion are scrambled. Other bits of the preamble, namely, for example, bits of the start-of-stream delimiter (SSD) are not scrambled. The SSD is located a known number of bits from the SFD. Thus, predetermined value 226 may represent the distance, in bits, between an SSD and an SFD (i.e., represent a number of clock cycles, or a number of bits for a respective bit rate, between an SSD and an SFD).

Optional adjustment logic 224 may add or subtract predetermined value 226 to, or from, counted number of clock cycles 204 depending on whether the detectable portion of the frame is located ahead or behind a portion of interest of the frame. By way of non-limiting example where an SSD occurs before an SFD, in a receiving example, where a value output by apparatus 200 is expected to represent latency of a frame traveling from PHY-cable interface 106 to PHY-MAC interface 110, optional adjustment logic 224 subtracts predetermined value 226 from counted number of clock cycles 204. In a transmission example, where a value output by apparatus 200 is expected to represent latency of a frame traveling from PHY-MAC interface 110 to PHY-cable interface 106, optional adjustment logic 224 adds predetermined value 226 to counted number of clock cycles 204.

In one or more examples, counting logic 202 may set a value of time duration value 118 automatically (e.g., counted number of clock cycles 204 is directly coupled to time duration value 118 via optional adjustment logic 224 to adjust according to predetermined values, without limitation), or selectively. In examples where time duration value 118 is set selectively, apparatus 200 may include optional gating circuit 218, coupled to an output of counting logic 202, or to an output of optional adjustment logic 224, if provided, to selectively enable recording of counted number of clock cycles 204 as time duration value 118. Gating circuit 218 may include message type detection logic 214 coupled with a gate 212 (e.g., with an asserted indication 216 coupled to an enable input of gate 212, without limitation). Message type detection logic 214 and gate 212 may be coupled to propagate counted number of clock cycles 204 at least partially responsive to detecting frames 222 that correspond to a predetermined frame type.

As a non-limiting example, when different types of frames travel via a datapath 220, the latency of some frames types may be of interest (e.g., 1588 PTP frames such as synchronization frames, follow_up frames, delay_request frames, or delay_response frames, without limitation) while latency of other frames types are not of interest. Message type detection logic 214 may be or include, as a non-limiting example, a pattern matcher to detect a frame type of a frame at least partially based on the frames 222 exhibiting a predetermined pattern of bits or symbols (e.g., bits or symbols in a field of frames 222 that corresponds to its type, without limitation) and assert indication 216 in response thereto. An enable input of gate 212 may be coupled to receive the asserted indication 216 such that gate 212 propagates the signals for counted number of clock cycles 204 when gate 212 receives the asserted indication 216. Gate 212 is disabled when indication 216 is un-asserted, and when disabled, gate 212, and gating circuit 218 more generally, does not propagate counted number of clock cycles 204.

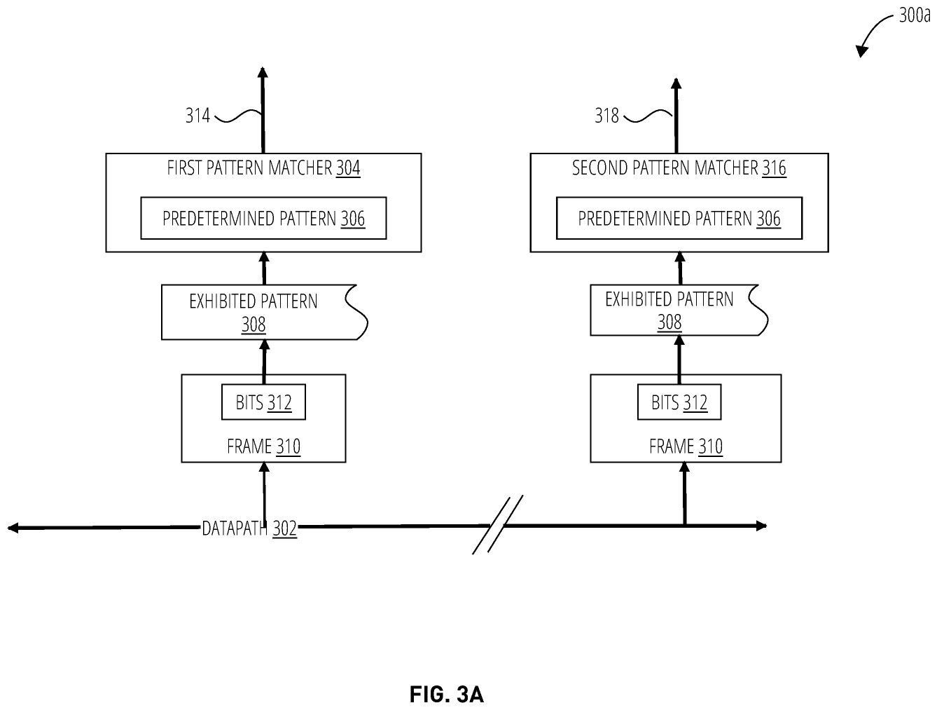

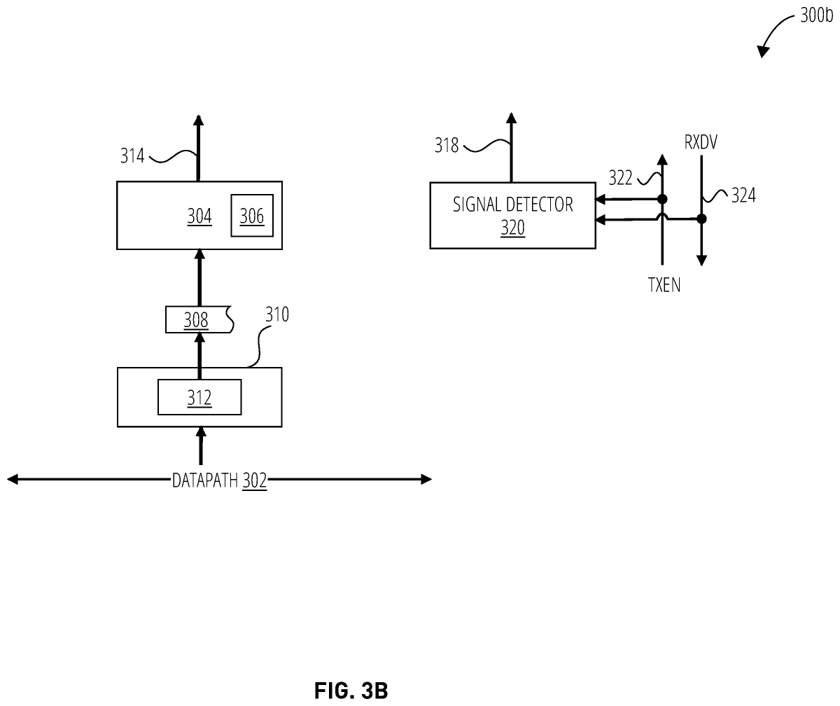

FIG. 3A is a diagram depicting an apparatus 300a to detect a presence of a frame at predetermined reference plane 112 of PHY-MAC interface 110 and at predetermined reference plane 108 of PHY-cable interface 106, in accordance with one or more examples.

In one or more examples, apparatus 300a includes first pattern matcher 304 and second pattern matcher 316 respectively coupled to observe a frame 310 at a datapath 302. In one or more examples, first pattern matcher 304 may be coupled to a portion of the reception datapath 302 that follows a media-dependent interface (MDI) that operates as a PHY-cable interface but prior to the physical coding sublayer (PCS) responsible at the PHY for, as non-limiting examples: encoding, decoding, scrambling, descrambling, alignment market insertion and removal, block and symbol deskew. Second pattern matcher 316 may be coupled to a portion of datapath 302 that includes a connection with the PHY-MAC interface 110 or a connection within the PHY-MAC interface 110.

First pattern matcher 304 detects that a pattern exhibited by bits 312 of frame 310 (i.e., exhibited pattern 308) corresponds to a predetermined pattern 306 and asserts indication 314 indicative of detection of the predetermined pattern 306 at least partially responsive thereto. Indication 314 is a non-limiting example of indication 210 which is an indication of presence of the frame at the predetermined reference plane 108 of PHY-cable interface 106.

Second pattern matcher 316 detects that a pattern exhibited by bits 312 of frame 310 (i.e., exhibited pattern 308) corresponds to a predetermined pattern 306 and assert indication 318 indicative of detection of the predetermined pattern 306 at least partially responsive thereto. Indication 318 is a non-limiting example of indication 208 which is an indication of presence of a frame at the predetermined reference plane 112 of PHY-MAC interface 110.

In one or more examples, predetermined pattern 306 is a pattern for an SSD of an Ethernet frame. An SSD is inserted at a preamble of an Ethernet frame by a transmitting PHY. In one or more examples, detection of an SSD may be utilized as an indication of an SFD or a preamble of an Ethernet frame, more generally. The number of bits between an SSD and an SFD of an Ethernet frame is generally known or specified.

FIG. 3B is a diagram depicting an apparatus 300b to detect a presence of a frame at predetermined reference plane 112 of PHY-MAC interface 110 and at predetermined reference plane 108 of PHY-cable interface 106, in accordance with one or more examples.

Whereas apparatus 300a includes two pattern matchers (first pattern matcher 304 and second pattern matcher 316) and associated circuits, apparatus 300b includes first pattern matcher 304 and associated circuits from apparatus 300a and a signal detector 320 coupled to first connection 322 and second connection 324 of a PHY-MAC interface, such as PHY-MAC interface 110. The coupled connections are generally connections for signals that indicate presence of a frame at PHY-MAC interface 110. In one or more examples, first connection 322 of PHY-MAC interface 110 may carry a signal that indicates a transmit frame is present at PHY-MAC interface 110, and second connection 324 of PHY-MAC interface 110 may carry a signal that indicates reception data is present at PHY-MAC interface 110. As a non-limiting example, first connection 322 may carry a “transmit enable” (TXEN) signal utilized by a media-independent-interface (MII), which, when asserted indicates presence of frame data on a transmit data connection of the MII, and when de-asserted indicates no frame data on the transmit data connection of the MII. As a non-limiting example, second connection 324 may carry a “receive data valid” (RXDV) signal utilized by an MII, which when asserted indicates presence of frame data on a receive data connection of the MII, and when de-asserted indicates no frame data is present on the receive data connection of the MII. Signal detector 320 may assert indication 318 in response to assertion of signals on first connection 322 or second connection 324, as the case may be.

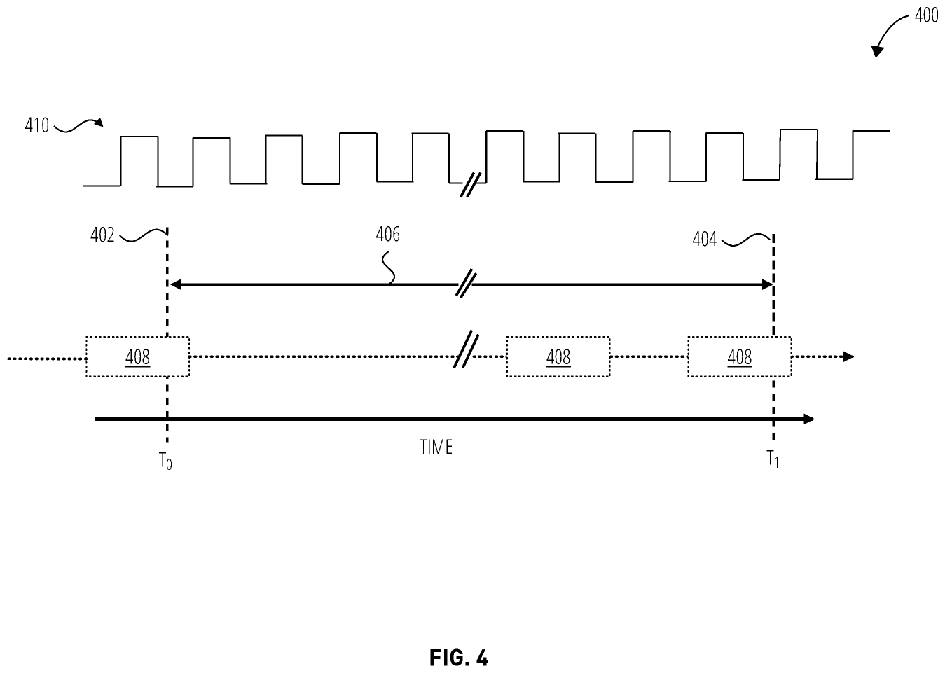

FIG. 4 is a timing diagram that depicts transfer 400 of a frame 408 in accordance with one or more examples. FIG. 4 depicts a specific non-limiting example of transfer of frame 408 over time. At time T0, a crossing of reference plane 402 by frame 408 is detected and at time T1, which occurs after time T0, a crossing of reference plane 404 by frame 408 is detected. Time duration 406 represents the elapsed time between time T1 and time T0. Time duration 406 may be captured by, as a non-limiting example, counting logic 202, and represented as a number or a count of clock cycles of clock signal 410 starting at time T0 and ending at time T1, which is stored as counted number of clock cycles 204.

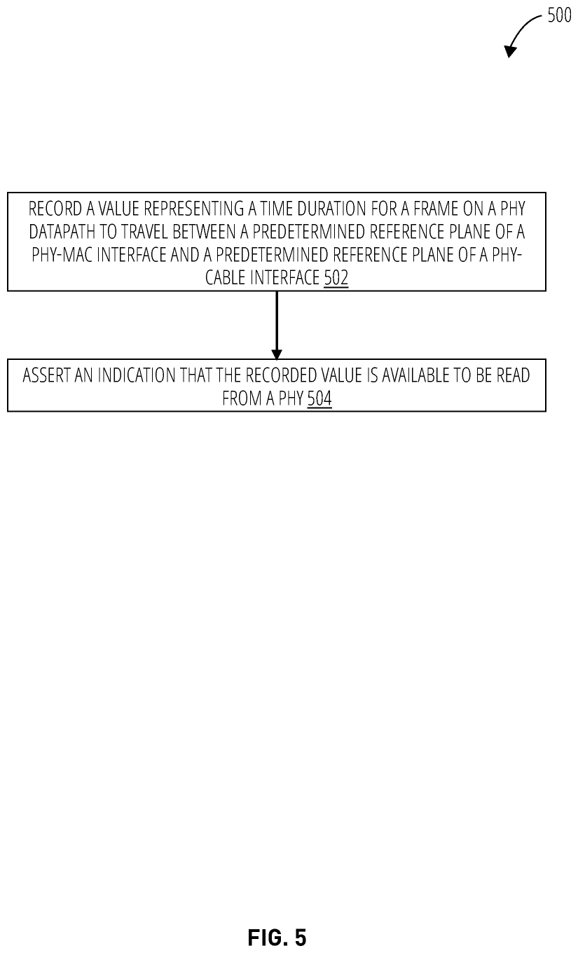

FIG. 5 is a flow diagram depicting a process 500 to determine and report latency in a 10SPE PHY, in accordance with one or more examples.

At operation 502, process 500 records a value (e.g., time duration value 118, without limitation) representing a time duration (e.g., value 118 time duration 406 of FIG. 4, without limitation) for a frame (e.g., frame 408 of FIG. 4, without limitation) traveling toward a cable so as to travel between a predetermined reference plane of a PHY-MAC interface (e.g., predetermined reference plane 112 of PHY-MAC interface 110 of FIG. 1 or reference plane 402 of FIG. 4, without limitation) and a predetermined reference plane of a PHY-cable interface (e.g., predetermined reference plane 108 of PHY-cable interface 106 of FIG. 1 or reference plane 404 of FIG. 4, without limitation).

At operation 504, process 500 asserts an indication (e.g., notification 116, without limitation) that the recorded value (e.g., time duration value 118, without limitation) is available to be read.

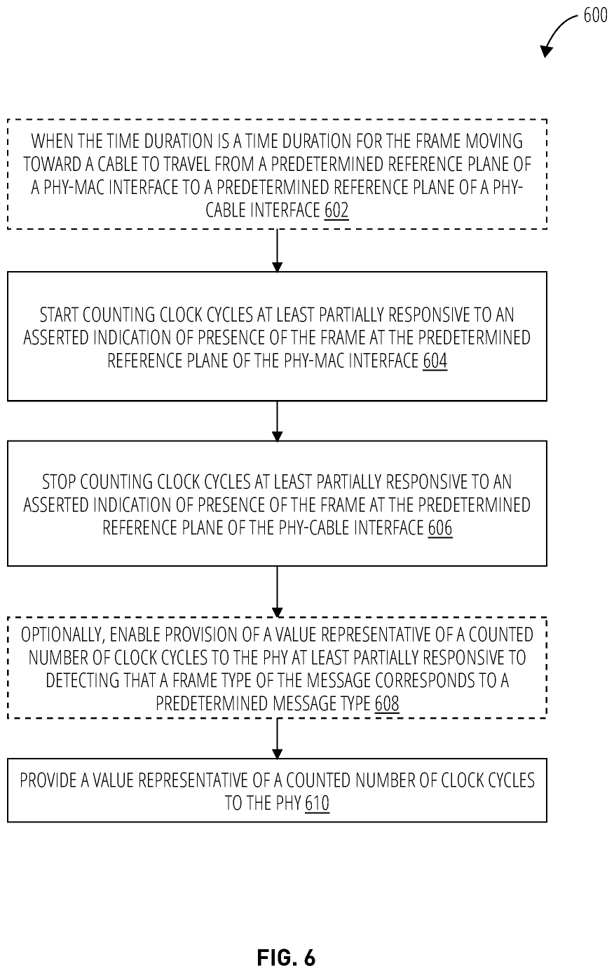

FIG. 6 is a flow diagram depicting a process 600 to determine latency of a 10SPE PHY, in accordance with one or more examples. In one or more examples, some or a totality of operations of process 600 may be performed by counting logic 202.

At operation 602, process 600 executes when the time duration is a time duration for the frame moving toward a cable to travel from a predetermined reference plane of a PHY-MAC interface to a predetermined reference plane of a PHY-cable interface.

At operation 604, process 600 starts counting clock cycles (e.g., at counting logic 202 of FIG. 2, without limitation) at least partially responsive to an asserted indication of presence of the frame at the predetermined reference plane of the PHY-MAC interface (e.g., responsive to indication 208 of FIG. 2, without limitation).

At operation 606, process 600 stops counting clock cycles at least partially responsive to an asserted indication of presence of the frame at the predetermined reference plane of the PHY-cable interface (e.g., responsive to indication 210 of FIG. 2, without limitation).

At operation 608, process 600 optionally enables provision of a value representative of a counted number of clock cycles to the PHY at least partially responsive to detecting (e.g., via message type detection logic 214 of FIG. 2, without limitation) that a frame type of the frame corresponds to a predetermined frame type.

At operation 610, process 600 provides the value representative of a counted number of clock cycles to the PHY.

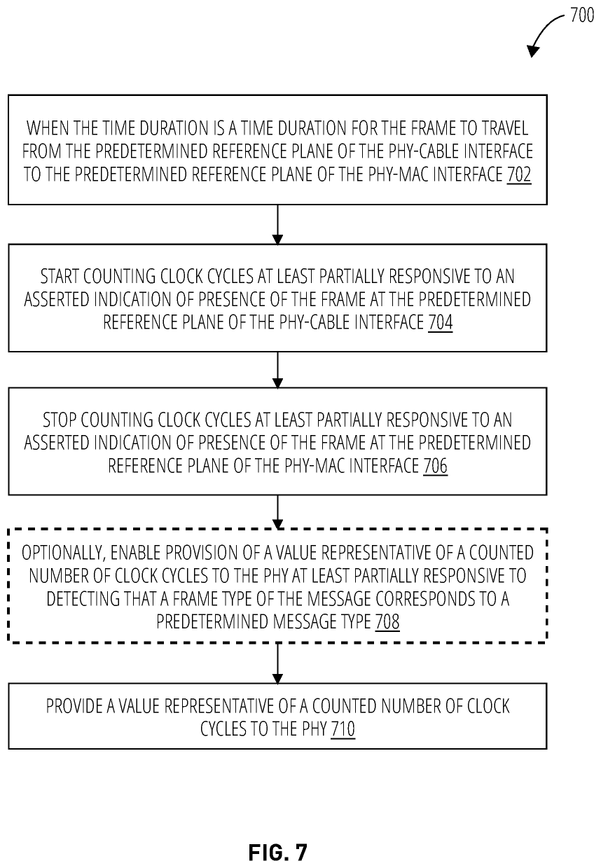

FIG. 7 is a flow diagram depicting process 700 to determine latency of a 10SPE PHY, in accordance with one or more examples. In one or more examples, some or a totality of operations of process 700 may be performed by counting logic 202.

At operation 702, process 700 executes when the time duration is a time duration for the frame to travel from the predetermined reference plane of the PHY-cable interface to the predetermined reference plane of the PHY-MAC interface.

At operation 704, process 700 starts counting clock cycles (e.g., at counting logic 202 of FIG. 2, without limitation) at least partially responsive to an asserted indication of presence of the frame at the predetermined reference plane of the PHY-cable interface (e.g., responsive to indication 210 of FIG. 2, without limitation).

At operation 706, process 700 stops counting clock cycles at least partially responsive to an asserted indication of presence of the frame at the predetermined reference plane of the PHY-MAC interface (e.g., responsive to indication 208 of FIG. 2, without limitation).

At operation 708, process 700 optionally enables enable provision of a value representative of a counted number of clock cycles to the PHY at least partially responsive to detecting (e.g., via message type detection logic 214 of FIG. 2, without limitation) that a frame type of the frame corresponds to a predetermined frame type.

At operation 710, process 700 provides a value representative of a counted number of clock cycles to the PHY.

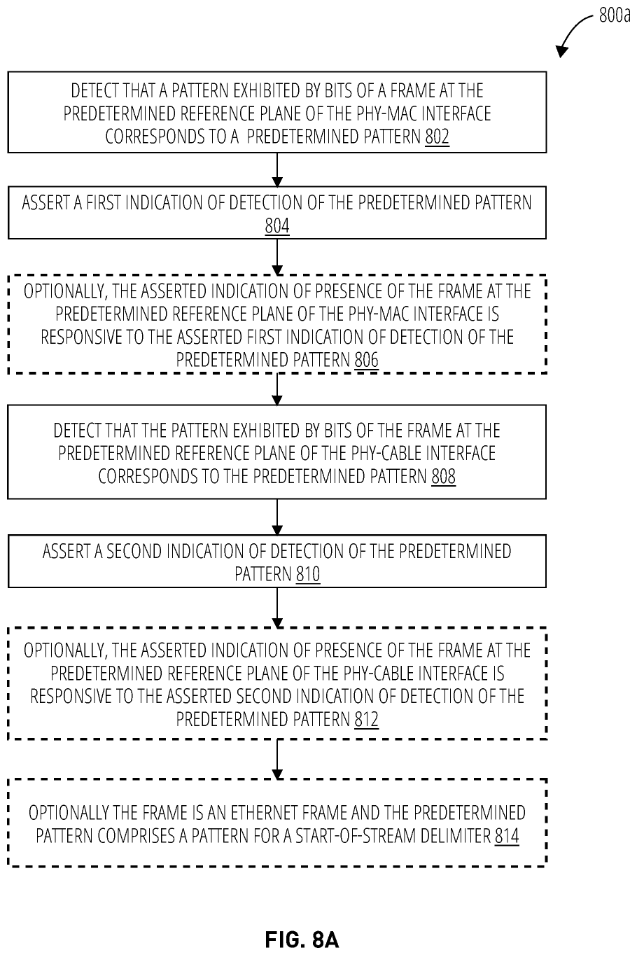

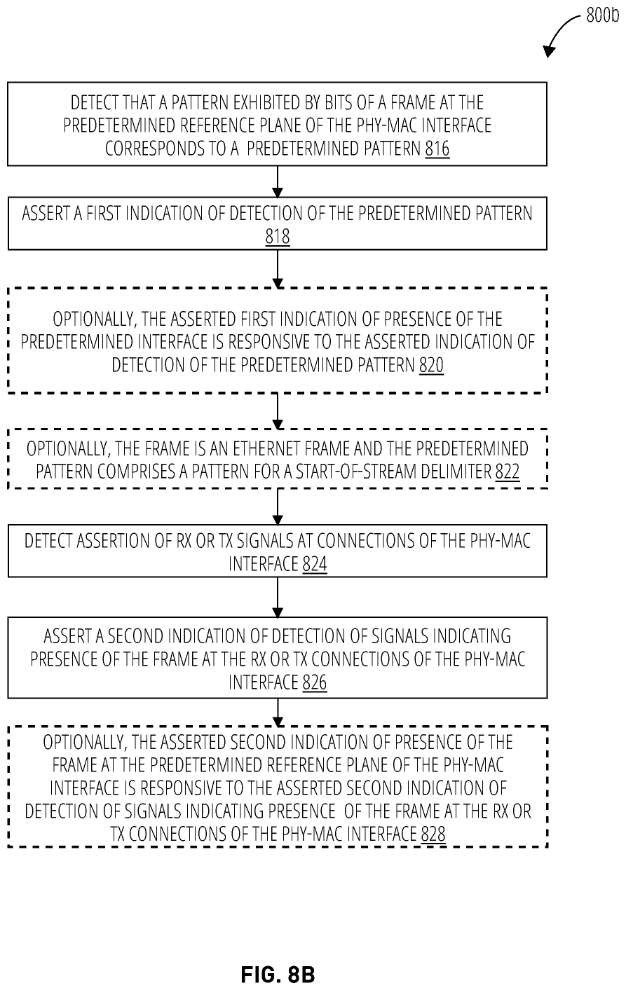

FIG. 8A is a flow diagram depicting a process 800a to detect a presence of a frame at predetermined reference planes, in accordance with one or more examples.

At operation 802, process 800a detects that a pattern exhibited (e.g., exhibited pattern 308, without limitation) by bits of a frame (e.g., bits 312 of frame 310, without limitation) at the predetermined reference plane of the PHY-MAC interface corresponds to a predetermined pattern (e.g., predetermined pattern 306, without limitation).

At operation 804, process 800a asserts a first indication of detection of the predetermined pattern (e.g., asserts indication 318, without limitation).

At operation 806, optionally the asserted first indication of presence of the frame at the predetermined reference plane of the PHY-MAC interface comprises the asserted indication of detection of the predetermined pattern.

At operation 808, process 800a further detects that a pattern exhibited (e.g., exhibited pattern 308, without limitation) by bits of the frame (e.g., bits 312 of frame 310, without limitation) at the predetermined reference plane of the PHY-Cable interface corresponds to the predetermined pattern (e.g., predetermined pattern 306, without limitation).

At operation 810, process 800a asserts a second indication of detection of the predetermined pattern (e.g., asserts indication 314, without limitation).

At operation 812, optionally the asserted indication of presence of the frame at the predetermined reference plane of the PHY-cable interface comprises the asserted second indication of detection of the predetermined pattern.

At operation 814, optionally the frame comprises an Ethernet frame and the predetermined pattern comprises a pattern for a start-of-stream delimiter and the predetermined pattern comprises a pattern for a start-of-stream delimiter.

FIG. 8B is a flow diagram depicting a process 800b to detect presence of a frame at predetermined reference planes, in accordance with one or more examples.

At operation 816, process 800b detects that a pattern exhibited (e.g., exhibited pattern 308, without limitation) by bits of a frame (e.g., bits 312 of frame 310, without limitation) corresponds to a predetermined pattern (e.g., predetermined pattern 306, without limitation).

At operation 818, process 800b asserts a first indication of detection of the predetermined pattern (e.g., asserts indication 314, without limitation).

At operation 820, optionally the asserted first indication of presence of the frame at the predetermined reference plane of the PHY-cable interface comprises the asserted first indication of detection of the predetermined pattern.

At operation 822, optionally the frame comprises an Ethernet frame and the predetermined pattern comprises a pattern for a start of stream delimiter and the predetermined pattern comprises a pattern for a start-of-stream delimiter.

At operation 824, process 800b detects assertion of RX or TX signals at connections (e.g., TXEN connection 322 or RXDV connection 324 of FIG. 3B, without limitation) of the PHY-MAC interface.

At operation 826, process 800b asserts a second indication of detection of signals indicating presence of the frame at the RX or TX connections of the PHY-MAC interface.

At operation 828, optionally the asserted second indication of presence of the frame at the predetermined reference plane of the PHY-MAC interface is responsive to the asserted indication of detection of signals indicating presence of the frame at the RX or TX connections of the PHY-MAC interface.

Sometimes the latency experienced by packets moving through a PHY changes. As a non-limiting example, PHYs that implement physical layer collision avoidance (PLCA) sometimes include delay lines or other mechanisms that change the travel time for packet to move through the PHY (toward a cable), sometimes unpredictably.

PTP (including gPTP, the automotive profile of PTP in 10SPE), utilizes four (4) frames to synchronize a slave clock to a master clock coupled over a computer network: a synchronization frame (SYNC) from the master to the slave, a follow up frame (FOLLOW_UP) from the master to the slave, a delay request frame (DELAY_REQUEST) from the slave to the master, and a delay response frame (DELAY_RESPONSE) from the slave to the master. The SYNC and DELAY_RESPONSE frames include timestamps generated by the master that represent the times at which the master sent the frames. The slave generates timestamps that respectively represent the times that the SYNC and DELAY_RESPONSE frames were received at the slave. The slave uses these generated timestamps to calculate an offset between the slave clock and the master clock, and, optionally, synchronizes its clock to the master clock.

In a typical arrangement, hardware timestamping is triggered at the master and the slave in response to respective detection of a SYNC frame or a DELAY_RESPONSE frame at respective MIIs. In these arrangements, a fixed latency between respective MDIs and the MIIs is assumed, and a value that represents the fixed latency is subtracted in the case of a reception and added in the case of a transmission. However, latency at a PHY may not be substantially fixed. For example, latency at a PLCA PHY may exhibit variance of as much as 80% of the frame time. Further, even if latency is substantially fixed at a PHY, it may not be known, as a non-limiting example, because it was not reasonably convenient to determine the latency.

One or more examples relate, generally, to generating timestamps for PTP or general PTP (gPTP) clock synchronization utilizing time duration values determined as disclosed above (e.g., a time duration value 118, without limitation) to represent latency of a PHY.

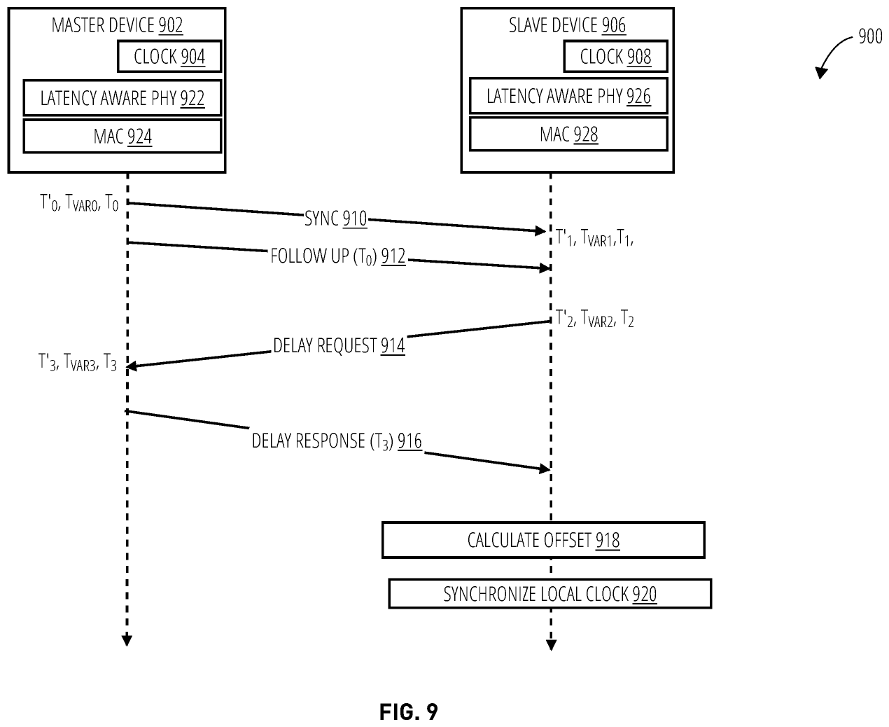

FIG. 9 is a flow diagram depicting a clock synchronization process 900, in accordance with one or more examples. In the non-limiting example depicted by FIG. 9, clock 908 of slave device 906 is to be synchronized to clock 904 of master device 902. One or both of master device 902 and slave device 906 include a “latency aware” PHY that determines latency according to examples discussed with reference to FIGS. 1 to 8 and a MAC that reads time duration values (e.g., time duration values 118) from a respective latency aware PHY and utilizes the time duration value to calculate timestamps utilized for PTP 1588 timestamps and synchronizing clocks, more generally. In this specific example, master device 902 includes latency aware PHY 922 (“PHY 922”) and MAC 924, and slave device 906 includes latency aware PHY 926 (“PHY 926”) and MAC 928.

At operation 910, master device 902 send a SYNC frame to slave device 906.

MAC 924 of master device 902 generates a timestamp T′0 that represents the time the SYNC frame is detected at the PHY-MAC interface (e.g., RMII or MII, without limitation) of master device 902, and reads from latency aware PHY 922 a time duration value TVAR0 that represents the latency of PHY 922 at master device 902 determined as discussed, above. MAC 924 of master device 902 calculates a further timestamp T0, that represents the time the SYNC frame was at a PHY-cable interface (e.g., a reference plane defined at an MDI, without limitation) of master device 902, according to the expression T0=T′0+TVAR0. MAC 924 of master 902 sends timestamp T′0 with the SYNC frame.

MAC 928 of slave device 906 generates a timestamp T′1 that represents a time the SYNC frame is detected at a PHY-MAC interface (e.g., RMII or MII, without limitation) of slave device 906, and reads, from latency aware PHY 926, a time duration value TVAR1 that represents the latency of latency aware PHY 926 at slave device 906 determined as discussed, above. MAC 928 of slave device 906 calculates a further timestamp T1, that represents the time the SYNC frame was at a PHY-cable interface (e.g., MDI, without limitation) of slave device 906, according to the expression T1=T′1−TVAR1.

At operation 912, master device 902 sends a FOLLOW_UP frame to slave device 906. The FOLLOW_UP frame includes timestamp T0 or derivative thereof.

At operation 914, slave device 906 sends a DELAY_REQUEST frame to master device 902, in response to receipt of the FOLLOW_UP frame.

MAC 928 of slave device 906 generates a timestamp T′2 that represents the time the DELAY_REQUEST frame is detected at the PHY-MAC interface (e.g., MII, without limitation) of slave device 906, and reads from latency aware PHY 926 a time duration value TVAR2 that represents the latency of PHY 926 at slave device 906 determined as discussed, above. Timestamp T′2 is sent with the DELAY_REQUEST frame. MAC 928 of slave device 906 calculates a further timestamp T2, that represents the time the DELAY_REQUEST frame was at a PHY-Cable interface (e.g., MDI, without limitation) of slave device 906, according to the expression T2=T′2+TVAR2.

MAC 924 of master device 902 generates a timestamp T′3 that represents a time the DELAY_REQUEST frame is detected at the PHY-MAC interface (e.g., MII, without limitation) of master device 902, and reads from latency aware PHY 922 a time duration value TVAR3 that represents the latency of latency aware PHY 922 at master device 902 determined as discussed, above. MAC 924 of master device 902 calculates a further timestamp T3, that represents the time the DELAY_REQUEST frame was at a PHY-cable interface (e.g., MDI, without limitation) of master device 902, according to the expression T3=T′3−TVAR3.

At operation 916, master device 902 sends a DELAY_RESPONSE frame to slave device 906. The DELAY_RESPONSE frame includes timestamp T3 or a derivative thereof.

At operation 918, MAC 928 of slave device 906 calculates an offset between clock 908 of slave device 906 and clock 904 of master device 902 utilizing timestamps T0, T1, T2, and T3.

At operation 920, MAC 928 of slave device 906 synchronizes the local clock 908 to the master clock 904 utilizing the calculated offset.

In one or more foregoing examples discussed with respect to FIG. 9, a single respective latency value was utilized to cancel the latency from respective timestamps, but this disclosure is not so limited. As a non-limiting example, it is specifically contemplated that multiple latency values may be utilized to cancel latency from respective timestamps, including further time duration values generated as disclosed herein, pre-determined fixed delay values that represent a portion of substantially fixed latency in a PHY, and combinations thereof, without limitation.

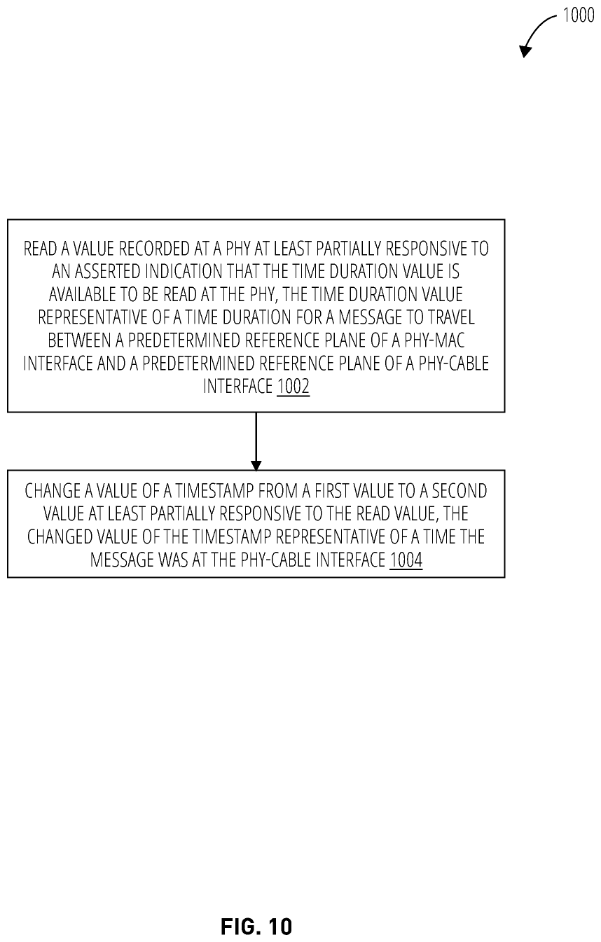

FIG. 10 is a flow diagram depicting a process 1000 for cancelling latency of a PHY from timestamp, in accordance with one or more examples.

Process 1000 may be performed, as a non-limiting example, by a MAC that implements PTP, in either the master (e.g., as part of a master device 902, without limitation) or slave context (e.g., as part of a slave device 906, without limitation).

At operation 1002, process 1000 reads a time duration value recorded at a PHY at least partially responsive to an asserted indication that the time duration value is available to be read at the PHY. The time duration value is representative of a latency of the PHY. In one or more examples, the time duration value is representative of a time duration for a frame to travel between a predetermined reference plane of a PHY-MAC interface and a predetermined reference plane of a PHY-cable interface.

In one or more examples, a time duration value may be representative of a latency of the PHY when a frame is moving from a MAC toward a cable (e.g., transmission of SYNC frame of operation 910 or DELAY_REQUEST frame of operation 914, without limitation), or a time duration value may be representative of a latency of the PHY when a frame is moving from a cable toward a MAC (e.g., reception of SYNC frame of operation 910 or DELAY_REQUEST frame of operation 914, without limitation).

At operation 1004, process 1000 changes a value of a timestamp from a first value to a second value at least partially responsive to the time duration value. The changed value of the timestamp is representative of a time when the frame was at the PHY-cable interface. The value of the timestamp is intended to represent a time the frame was at a PHY-cable interface, but the first value is representative of a time the frame was at the PHY-MAC interface. Thus, changing the value of the timestamp from the first value to the second value utilizing the time duration value improves the degree to which the value of the timestamp is representative of the time when the frame was at the PHY-cable interface.

Some or a totality of synchronization process 900 may be performed for each timestamp for which latency cancellation is desired.

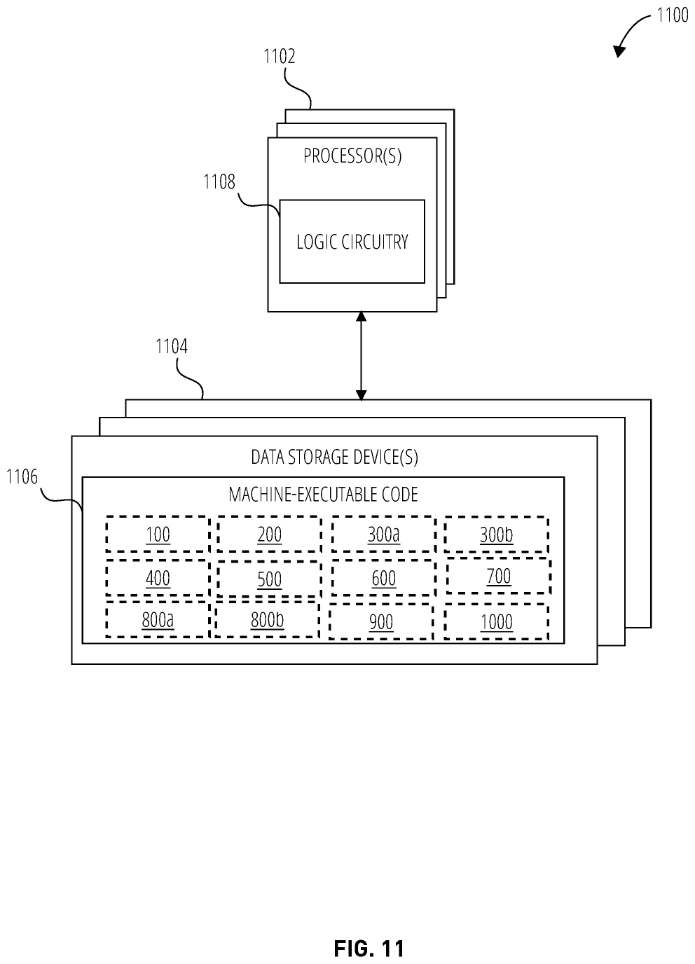

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 11 illustrates non-limiting examples of implementations of functional elements disclosed herein. In some examples, some or all portions of the functional elements disclosed herein may be performed by hardware specially configured for carrying out the functional elements.

FIG. 11 is a block diagram of circuitry 1100 that, in some examples, may be used to implement various functions, operations, acts, processes, and/or methods disclosed herein. The circuitry 1100 includes one or more processors 1102 (sometimes referred to herein as “processors 1102”) operably coupled to one or more data storage devices (sometimes referred to herein as “storage 1104”). The storage 1104 includes machine-executable code 1106 stored thereon and the processors 1102 include logic circuitry 1108. The machine-executable code 1106 includes information describing functional elements that may be implemented by (e.g., performed by) the logic circuitry 1108. The logic circuitry 1108 is adapted to implement (e.g., perform) the functional elements described by the machine-executable code 1106. The circuitry 1100, when executing the functional elements described by the machine-executable code 1106, should be considered as special purpose hardware configured for carrying out functional elements disclosed herein. In some examples the processors 1102 may be configured to perform the functional elements described by the machine-executable code 1106 sequentially, concurrently (e.g., on one or more different hardware platforms), or in one or more parallel process streams.

When implemented by logic circuitry 1108 of the processors 1102, the machine-executable code 1106 is configured to adapt the processors 1102 to perform operations of examples disclosed herein. By way of non-limiting example, the machine-executable code 1106 may be configured to adapt the processors 1102 to perform some or a totality of operations of one or more of: transfer 400, process 500, process 600, process 700, process 800a, synchronization process 900, or process 1000. Also by way of non-limiting example, the machine-executable code 1106 may be configured to adapt the processors 1102 to perform some or a totality of features, functions, or operations disclosed herein for one or more of: apparatus 100, apparatus 200, or apparatus 300a, and more specifically, one or more of: memory 102, logic circuit 104, PHY-cable interface 106, PHY-MAC interface 110, counting logic 202, gating circuit 218, gate 212, message type detection logic 214, second pattern matcher 316, first pattern matcher 304, master device 902, or slave device 906.

The processors 1102 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 1106 (e.g., software code, firmware code, hardware descriptions) related to examples of the present disclosure. It is noted that a general-purpose processor (may also be referred to herein as a host processor or simply a host) may be a microprocessor, but in the alternative, the processors 1102 may include any conventional processor, controller, microcontroller, or state machine. The processors 1102 may also be implemented as a combination of computing devices, such as a combination of a DSP and a microprocessor, a plurality of microprocessors, one or more microprocessors in conjunction with a DSP core, or any other such configuration.

In some examples the storage 1104 includes volatile data storage (e.g., random-access memory (RAM)), non-volatile data storage (e.g., Flash memory, a hard disc drive, a solid state drive, erasable programmable read-only memory (EPROM), etc.). In some examples the processors 1102 and the storage 1104 may be implemented into a single device (e.g., a semiconductor device product, a system on chip (SOC), etc.). In some examples the processors 1102 and the storage 1104 may be implemented into separate devices.

In some examples the machine-executable code 1106 may include computer-readable instructions (e.g., software code, firmware code). By way of non-limiting example, the computer-readable instructions may be stored by the storage 1104, accessed directly by the processors 1102, and executed by the processors 1102 using at least the logic circuitry 1108. Also by way of non-limiting example, the computer-readable instructions may be stored on the storage 1104, transferred to a memory device (not shown) for execution, and executed by the processors 1102 using at least the logic circuitry 1108. Accordingly, in some examples the logic circuitry 1108 includes electrically configurable logic circuitry 1108.

In some examples the machine-executable code 1106 may describe hardware (e.g., circuitry) to be implemented in the logic circuitry 1108 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG®, System Verilog™ or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1108 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1106 may include an HDL, an RTL, a GL description, a mask level description, other hardware description, or any combination thereof.

In examples where the machine-executable code 1106 includes a hardware description (at any level of abstraction), a system (not shown, but including the storage 1104) may be configured to implement the hardware description described by the machine-executable code 1106. By way of non-limiting example, the processors 1102 may include a programmable logic device (e.g., an FPGA or a PLC) and the logic circuitry 1108 may be electrically controlled to implement circuitry corresponding to the hardware description into the logic circuitry 1108. Also by way of non-limiting example, the logic circuitry 1108 may include hard-wired logic manufactured by a manufacturing system (not shown, but including the storage 1104) according to the hardware description of the machine-executable code 1106.

Regardless of whether the machine-executable code 1106 includes computer-readable instructions or a hardware description, the logic circuitry 1108 is adapted to perform the functional elements described by the machine-executable code 1106 when implementing the functional elements of the machine-executable code 1106. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.). As used herein, the term “each” means “some or a totality,” and the term “each and every” means “a totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

One or more non-limiting examples of the disclosure may include:

Example 1: A method, comprising: recording a value representing a time duration for a frame on a PHY datapath to travel between a predetermined reference plane of a PHY-MAC interface and a predetermined reference plane of a PHY-cable interface; and asserting an indication that the recorded value is available to be read from a PHY.

Example 2: The method according to Example 1, wherein the time duration for the frame to travel between the predetermined reference plane of the PHY-MAC interface and the predetermined reference plane of the PHY-cable interface comprises: a time duration for the frame to travel from the predetermined reference plane of the PHY-MAC interface to the predetermined reference plane of the PHY-cable interface.

Example 3: The method according to any of Examples 1 and 2, comprising: starting counting clock cycles at least partially responsive to an asserted indication of presence of the frame at the predetermined reference plane of the PHY-MAC interface; stopping counting clock cycles at least partially responsive to an asserted indication of presence of the frame at the predetermined reference plane of the PHY-cable interface; and setting the value to a counted number of clock cycles.

Example 4: The method according to any of Examples 1 through 3, comprising: detecting a pattern exhibited by bits of the frame at the predetermined reference plane of the PHY-MAC interface corresponds to a predetermined pattern; asserting a first indication of detection of the predetermined pattern, wherein the asserted indication of presence of the frame at the predetermined reference plane of the PHY-MAC interface is responsive to the first indication of detection of the predetermined pattern; detecting the pattern exhibited by the bits of the frame at the predetermined reference plane of the PHY-cable interface corresponds to the predetermined pattern; and asserting a second indication of detection of the predetermined pattern, wherein the asserted indication of presence of the frame at the predetermined reference plane of the PHY-cable interface is responsive to the second indication of detection of the predetermined pattern.

Example 5: The method according to any of Examples 1 through 4, comprising: enabling provision of a value representative of a counted number of clock cycles to the PHY at least partially responsive to detecting that a frame type of the frame corresponds to a predetermined frame type.

Example 6: The method according to any of Examples 1 through 5, comprising: reading the value recorded at the PHY at least partially responsive to the asserted indication that the value is available to be read at the PHY, the value representative of a latency of the PHY; and changing a value of a timestamp from a first value to a second value at least partially responsive to the read value, the changed value of the timestamp representative of a time the frame was at the PHY-cable interface.

Example 7: The method according to any of Examples 1 through 6, wherein the time duration for the frame to travel between the predetermined reference plane of the PHY-MAC interface and the predetermined reference plane of the PHY-cable interface comprises: a time duration for the frame to travel from the predetermined reference plane of the PHY-cable interface to the predetermined reference plane of the PHY-MAC interface.

Example 8: The method according to any of Examples 1 through 7, comprising: starting counting clock cycles at least partially responsive to an asserted indication of presence of the frame at the predetermined reference plane of the PHY-cable interface; stopping counting clock cycles at least partially responsive to an asserted indication of presence of the frame at the predetermined reference plane of the PHY-MAC interface; and setting the value to a counted number of clock cycles.

Example 9: The method according to any of Examples 1 through 8, comprising: detecting that a pattern exhibited by bits of a frame at the predetermined reference plane of the PHY-cable interface corresponds to a predetermined pattern; asserting a first indication of detection of the predetermined pattern, wherein the asserted indication of presence of the frame at the predetermined reference plane of the PHY-cable interface is responsive to the asserted first indication of detection of the predetermined pattern; detecting the pattern exhibited by bits of the frame at the predetermined reference plane of the PHY-MAC interface corresponds to the predetermined pattern; and asserting a second indication of detection of the predetermined pattern, wherein the asserted indication of presence of the frame at the predetermined reference plane of the PHY-MAC interface is responsive to the asserted second indication of detection of the predetermined pattern.

Example 10: The method according to any of Examples 1 through 9, comprising: reading the value recorded at the PHY at least partially responsive to the asserted indication that the value is available to be read at the PHY, the value representative of a latency of the PHY; and changing a value of a timestamp from a first value to a second value at least partially responsive to the read value, the changed value of the timestamp representative of a time the frame was at the PHY-cable interface.

Example 11: An apparatus, comprising: a memory and a logic circuit provided at a PHY, the memory and the logic circuit coupled to: record a value that represents a time duration for a frame at a datapath of the PHY to travel between a predetermined reference plane of a PHY-MAC interface and a predetermined reference plane of a PHY-cable interface; and assert an indication that the recorded value is available to be read from the memory.

Example 12: The apparatus according to Example 11, wherein the time duration for the frame at the datapath of the PHY to travel between the predetermined reference plane of the PHY-MAC interface and the predetermined reference plane of the PHY-cable interface comprises: the time duration for the frame to travel from the predetermined reference plane of the PHY-MAC interface to the predetermined reference plane of a PHY-cable interface.

Example 13: The apparatus according to any of Examples 11 and 12, wherein the logic circuit comprises a counter logic to: start counting clock cycles at least partially responsive to an asserted indication of presence of the frame at the predetermined reference plane of the PHY-MAC interface; and stop counting clock cycles at least partially responsive to an asserted indication of presence of the frame at the predetermined reference plane of the PHY-cable interface, wherein the logic circuit to set the value according to a counted number of clock cycles.

Example 14: The apparatus according to any of Examples 11 through 13, wherein the logic circuit comprises a first and a second pattern detector logic respectively coupled to observe a frame at a transmission path of the PHY, the first pattern detector logic to: detect a pattern exhibited by bits of the frame at the predetermined reference plane of the PHY-MAC interface corresponds to a predetermined pattern; and assert a first indication of detection of the predetermined pattern, wherein the asserted indication of presence of the frame at the predetermined reference plane of the PHY-MAC interface is responsive to the asserted first indication of detection of the predetermined pattern; the second pattern detector logic to: detect the pattern exhibited by bits of the frame at the predetermined reference plane of the PHY-Cable interface corresponds to the predetermined pattern; and assert a second indication of detection of the predetermined pattern, wherein the asserted indication of presence of the frame at the predetermined reference plane of the PHY-Cable interface is responsive to the asserted second indication of detection of the predetermined pattern.

Example 15: The apparatus according to any of Examples 11 through 14, wherein the frame is an Ethernet frame and the predetermined pattern comprises a pattern for a start-of-stream delimiter.

Example 16: The apparatus according to any of Examples 11 through 15, wherein the logic circuit comprises a gating circuit to selectively provision of a value representative of a counted number of clock cycles to the PHY at least partially responsive to detecting that a frame type of the frame corresponds to a predetermined frame type.

Example 17: The apparatus according to any of Examples 11 through 16, wherein the time duration for the frame at the datapath of the PHY to travel between the predetermined reference plane of the PHY-MAC interface and the predetermined reference plane of the PHY-cable interface comprises: the time duration for the frame to travel from a predetermined reference plane of a PHY-cable interface to a predetermined reference plane of a PHY-MAC interface.

Example 18: The apparatus according to any of Examples 11 through 17, wherein the logic circuit comprises a counter logic to: start counting clock cycles at least partially responsive to an asserted indication of presence of the frame at the predetermined reference plane of the PHY-cable interface; and stop counting clock cycles at least partially responsive to an asserted indication of presence of the frame at the predetermined reference plane of the PHY-MAC interface, wherein the logic circuit to set the value according to a counted number of clock cycles.

Example 19: The apparatus according to any of Examples 11 through 18, wherein the logic circuit comprises a first and a second pattern detector logic respectively coupled to observe a frame at a reception path of the PHY, a first pattern matcher to: detect that a pattern exhibited by bits of the frame at the predetermined reference plane of the PHY-cable interface corresponds to a predetermined pattern; and assert an indication of detection of the predetermined pattern, wherein the asserted indication of presence of the frame at the predetermined reference plane of the PHY-cable interface is responsive to the asserted indication of detection of the predetermined pattern by the first pattern matcher; a second pattern matcher to: detect that the pattern exhibited by bits of the frame at the predetermined reference plane of the PHY-MAC interface corresponds to the predetermined pattern; and assert an indication of detection of the predetermined pattern, wherein the asserted indication of presence of the frame at the predetermined reference plane of the PHY-MAC interface is responsive to the asserted indication of detection of the predetermined pattern by the second pattern matcher.

Example 20: The apparatus according to any of Examples 11 through 19, wherein the frame is an Ethernet frame and the predetermined pattern comprises a pattern for a start-of-stream delimiter.

Example 21: A system, comprising: a physical layer to: record a value representative of a time duration for a frame to travel between a predetermined reference plane of a PHY-MAC interface and a predetermined reference plane of a PHY-cable interface; and assert an indication that the recorded value is available to be read from the physical layer, and a media access controller to: read the value recorded at the time duration at least partially responsive to the asserted indication that the value is available to be read at the physical layer; and change a value of a timestamp from a first value to a second value at least partially responsive to the read value, the changed value of the timestamp representative of a time the frame was at the PHY-cable interface.

Example 22: The system according to Example 21, wherein the media access controller is coupled with the physical layer via the PHY-MAC interface to read the value.

Example 23: The system according to any of Examples 21 and 22, wherein the media access controller to implement a precision time protocol, and the frame is one of a SYNCHRONIZATION frame or a DELAY_REQUEST frame.

Example 24: The system according to any of Examples 21 through 23, wherein the media access controller and the physical layer are provided at a device that includes a mater clock of a precision time protocol synchronization process.

Example 25: The system according to any of Examples 21 through 24, wherein the media access controller and the PHY-cable interface are provided at a device that includes a slave clock of a 1588 precision time protocol synchronization process.

Example 26: The system according to any of Examples 21 through 25, wherein the media access controller and the physical layer are provided at a device that includes a clock of a precision time protocol synchronization process.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method, comprising:
recording a value representing a time duration for a frame on a PHY datapath to travel between a predetermined reference plane of a PHY-MAC interface and a predetermined reference plane of a PHY-cable interface; and
asserting an indication that the recorded value is available to be read from a PHY.

2. The method of claim 1, wherein the time duration for the frame to travel between the predetermined reference plane of the PHY-MAC interface and the predetermined reference plane of the PHY-cable interface comprises:
a time duration for the frame to travel from the predetermined reference plane of the PHY-MAC interface to the predetermined reference plane of the PHY-cable interface.

3. The method of claim 2, comprising:
starting counting clock cycles at least partially responsive to an asserted indication of presence of the frame at the predetermined reference plane of the PHY-MAC interface;
stopping counting clock cycles at least partially responsive to an asserted indication of presence of the frame at the predetermined reference plane of the PHY-cable interface; and
setting the value to a counted number of clock cycles.

4. The method of claim 3, comprising:
detecting a pattern exhibited by bits of the frame at the predetermined reference plane of the PHY-MAC interface corresponds to a predetermined pattern;
asserting a first indication of detection of the predetermined pattern, wherein the asserted indication of presence of the frame at the predetermined reference plane of the PHY-MAC interface is responsive to the first indication of detection of the predetermined pattern;
detecting the pattern exhibited by the bits of the frame at the predetermined reference plane of the PHY-cable interface corresponds to the predetermined pattern; and
asserting a second indication of detection of the predetermined pattern, wherein the asserted indication of presence of the frame at the predetermined reference plane of the PHY-cable interface is responsive to the second indication of detection of the predetermined pattern.

5. The method of claim 2, comprising:
enabling provision of a value representative of a counted number of clock cycles to the PHY at least partially responsive to detecting that a frame type of the frame corresponds to a predetermined frame type.

6. The method of claim 2, comprising:
reading the value recorded at the PHY at least partially responsive to the asserted indication that the value is available to be read at the PHY, the value representative of a latency of the PHY; and
changing a value of a timestamp from a first value to a second value at least partially responsive to the read value, the changed value of the timestamp representative of a time the frame was at the PHY-cable interface.

7. The method of claim 1, wherein the time duration for the frame to travel between the predetermined reference plane of the PHY-MAC interface and the predetermined reference plane of the PHY-cable interface comprises:
a time duration for the frame to travel from the predetermined reference plane of the PHY-cable interface to the predetermined reference plane of the PHY-MAC interface.

8. The method of claim 7, comprising:
starting counting clock cycles at least partially responsive to an asserted indication of presence of the frame at the predetermined reference plane of the PHY-cable interface;
stopping counting clock cycles at least partially responsive to an asserted indication of presence of the frame at the predetermined reference plane of the PHY-MAC interface; and
setting the value to a counted number of clock cycles.

9. The method of claim 8, comprising:
detecting that a pattern exhibited by bits of a frame at the predetermined reference plane of the PHY-cable interface corresponds to a predetermined pattern;
asserting a first indication of detection of the predetermined pattern,
wherein the asserted indication of presence of the frame at the predetermined reference plane of the PHY-cable interface is responsive to the asserted first indication of detection of the predetermined pattern;
detecting the pattern exhibited by bits of the frame at the predetermined reference plane of the PHY-MAC interface corresponds to the predetermined pattern; and
asserting a second indication of detection of the predetermined pattern,
wherein the asserted indication of presence of the frame at the predetermined reference plane of the PHY-MAC interface is responsive to the asserted second indication of detection of the predetermined pattern.

10. The method of claim 7, comprising:
reading the value recorded at the PHY at least partially responsive to the asserted indication that the value is available to be read at the PHY, the value representative of a latency of the PHY; and
changing a value of a timestamp from a first value to a second value at least partially responsive to the read value, the changed value of the timestamp representative of a time the frame was at the PHY-cable interface.

11. An apparatus, comprising:
a memory and a logic circuit provided at a PHY, the memory and the logic circuit coupled to:
record a value that represents a time duration for a frame at a datapath of the PHY to travel between a predetermined reference plane of a PHY-MAC interface and a predetermined reference plane of a PHY-cable interface; and
assert an indication that the recorded value is available to be read from the memory.

12. The apparatus of claim 11, wherein the time duration for the frame at the datapath of the PHY to travel between the predetermined reference plane of the PHY-MAC interface and the predetermined reference plane of the PHY-cable interface comprises:
the time duration for the frame to travel from the predetermined reference plane of the PHY-MAC interface to the predetermined reference plane of a PHY-cable interface.

13. The apparatus of claim 12, wherein the logic circuit comprises a counter logic to:
start counting clock cycles at least partially responsive to an asserted indication of presence of the frame at the predetermined reference plane of the PHY-MAC interface; and
stop counting clock cycles at least partially responsive to an asserted indication of presence of the frame at the predetermined reference plane of the PHY-cable interface,
wherein the logic circuit to set the value according to a counted number of clock cycles.

14. The apparatus of claim 13, wherein the logic circuit comprises a first and a second pattern detector logic respectively coupled to observe a frame at a transmission path of the PHY, the first pattern detector logic to:
detect a pattern exhibited by bits of the frame at the predetermined reference plane of the PHY-MAC interface corresponds to a predetermined pattern; and
assert a first indication of detection of the predetermined pattern,
wherein the asserted indication of presence of the frame at the predetermined reference plane of the PHY-MAC interface is responsive to the asserted first indication of detection of the predetermined pattern;
the second pattern detector logic to:
detect the pattern exhibited by bits of the frame at the predetermined reference plane of the PHY-Cable interface corresponds to the predetermined pattern; and
assert a second indication of detection of the predetermined pattern,
wherein the asserted indication of presence of the frame at the predetermined reference plane of the PHY-Cable interface is responsive to the asserted second indication of detection of the predetermined pattern.

15. The apparatus of claim 14, wherein the frame is an Ethernet frame and the predetermined pattern comprises a pattern for a start-of-stream delimiter.

16. The apparatus of claim 12, wherein the logic circuit comprises a gating circuit to selectively provision of a value representative of a counted number of clock cycles to the PHY at least partially responsive to detecting that a frame type of the frame corresponds to a predetermined frame type.

17. The apparatus of claim 11, wherein the time duration for the frame at the datapath of the PHY to travel between the predetermined reference plane of the PHY-MAC interface and the predetermined reference plane of the PHY-cable interface comprises:
the time duration for the frame to travel from a predetermined reference plane of a PHY-cable interface to a predetermined reference plane of a PHY-MAC interface.

18. The apparatus of claim 17, wherein the logic circuit comprises a counter logic to:
start counting clock cycles at least partially responsive to an asserted indication of presence of the frame at the predetermined reference plane of the PHY-cable interface; and
stop counting clock cycles at least partially responsive to an asserted indication of presence of the frame at the predetermined reference plane of the PHY-MAC interface,
wherein the logic circuit to set the value according to a counted number of clock cycles.

19. The apparatus of claim 18, wherein the logic circuit comprises a first and a second pattern detector logic respectively coupled to observe a frame at a reception path of the PHY, a first pattern matcher to:
detect that a pattern exhibited by bits of the frame at the predetermined reference plane of the PHY-cable interface corresponds to a predetermined pattern; and
assert an indication of detection of the predetermined pattern,
wherein the asserted indication of presence of the frame at the predetermined reference plane of the PHY-cable interface is responsive to the asserted indication of detection of the predetermined pattern by the first pattern matcher;
a second pattern matcher to:
detect that the pattern exhibited by bits of the frame at the predetermined reference plane of the PHY-MAC interface corresponds to the predetermined pattern; and
assert an indication of detection of the predetermined pattern,
wherein the asserted indication of presence of the frame at the predetermined reference plane of the PHY-MAC interface is responsive to the asserted indication of detection of the predetermined pattern by the second pattern matcher.

20. The apparatus of claim 19, wherein the frame is an Ethernet frame and the predetermined pattern comprises a pattern for a start-of-stream delimiter.

21. A system, comprising:
a physical layer to:
record a value representative of a time duration for a frame to travel between a predetermined reference plane of a PHY-MAC interface and a predetermined reference plane of a PHY-cable interface; and
assert an indication that the recorded value is available to be read from the physical layer, and
a media access controller to:
read the value recorded at the time duration at least partially responsive to the asserted indication that the value is available to be read at the physical layer; and
change a value of a timestamp from a first value to a second value at least partially responsive to the read value, the changed value of the timestamp representative of a time the frame was at the PHY-cable interface.

22. The system of claim 21, wherein the media access controller is coupled with the physical layer via the PHY-MAC interface to read the value.

23. The system of claim 21, wherein the media access controller to implement a precision time protocol, and the frame is one of a SYNCHRONIZATION frame or a DELAY_REQUEST frame.

24. The system of claim 21, wherein the media access controller and the physical layer are provided at a device that includes a mater clock of a precision time protocol synchronization process.

25. The system of claim 21, wherein the media access controller and the PHY-cable interface are provided at a device that includes a slave clock of a 1588 precision time protocol synchronization process.

26. The system of claim 21, wherein the media access controller and the physical layer are provided at a device that includes a clock of a precision time protocol synchronization process.
